(19) United States
(12) Patent Application Publication
(10) Pub. No.: US 2003/0182805 A1
(43) Pub. Date: Oct. 2, 2003

(54) Pruner device for high tree branches

(76) Inventor: Tom Lau, Marysville, CA (US)

Correspondence Address: STURM & FIX LLP, 206 SIXTH AVENUE, SUITE 1213, DES MOINES, IA, 50309-4076, US

(21) Appl. No.: 10/114,849

(22) Filed: Apr. 2, 2002

(51) Int. Cl. B26B 13/00

(52) U.S. Cl. 30/251

(57) ABSTRACT

A pruning device (10) for cutting the highest branches of a fruit tree or the like without the need to resort to the use of a ladder or elevated platform wherein the device (10) includes an elongated hollow shaft member (20) that slidably receives an even longer actuator rod (30) in a reciprocating fashion under the influence of a pair of actuator arm members (31) (32) pivotally associated with both the actuator rod (30) and the hollow shaft member (20); wherein a clipper member (40) is operatively associated with both the upper end of the actuator rod (30) and the upper portion of the hollow shaft member (20) to sever branches when the actuator arm members (31) (32) are brought toward one another.

### CROSS REFERENCE TO RELATED APPLICATIONS

Not applicable.

### BACKGROUND OF THE INVENTION

1. Field of the Invention

The present invention relates to the field of pruning devices in general and in particular to a pruning device capable of reaching the upper branches of a tree.

2. Description of Related Art

As can be seen by reference to the following U.S. Pat. Nos. 3,594,903; 5,454,165; 5,084,975; 3,882,599; and, 5,634,276, the prior art is replete with myriad and diverse long and short handled devices.

While all of the aforementioned prior art constructions are more than adequate for the basic purpose and function for which they have been specifically designed, they are uniformly deficient with respect to their failure to provide a simple, efficient, and practical pruning device specifically designed to prune high tree branches which incorporate ease of maneuverability and actuation in its design.

As most orchard owners in particular are all too well aware, the pruning of the upper branches of a fruit tree can be a very time consuming and labor intensive practice, yet it is also a chore that must be undertaken on a yearly basis in order to insure maximum fruit production from the orchard.

As a consequence of the foregoing situation, there has existed a longstanding need for a new and improved pruning device that is specifically designed to reach the upper branches of a tree without the aid of a stepladder and additional manpower requirements; and, the provision of such a device is the stated objective of the present invention.

### BRIEF SUMMARY OF THE INVENTION

Briefly stated, the pruning device that forms the basis of the present invention comprises in general a shaft unit, an actuator unit and a clipping unit wherein the actuator unit is partially disposed within the shaft unit and the clipping unit is operatively connected to both the shaft unit and the actuator unit.

As will be explained in greater detail further on in the specification, the shaft unit comprises an elongated hollow shaft member and the actuator unit includes an elongated actuator rod member that is slidably disposed within the hollow shaft member in a reciprocating fashion under the influence of a pair of actuator arm members pivotally connected on one end of the hollow shaft member and operatively associated with the actuator rod element via a pair of linkage arms.

In addition, the clipping unit includes a clipper member having a first stationary jaw element fixedly secured to the hollow shaft member and pivotally secured to a second moveable jaw element that is also pivotally secured to the top of the actuator rod element; wherein, the opening and closing movement of the actuator arm members coincides with the opening and closing movement of the jaw elements of the clipper member to effect pruning cuts of high tree limbs, branches, and stems.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the pruning device of this invention in use;

FIG. 2 is an isolated detail view of the pruning jaw members in their open position;

FIG. 3 is an isolated detail view of the pruning jaw members in their closed position;

FIG. 4 is an isolated detail view of the support yoke member;

FIG. 5 is a front elevation view of the device showing the jaw members and the actuating arm members in their open position; and,

FIG. 6 is a front elevation view of the device showing the jaw members and the actuating arm members in their closed position.

### DETAILED DESCRIPTION OF THE INVENTION

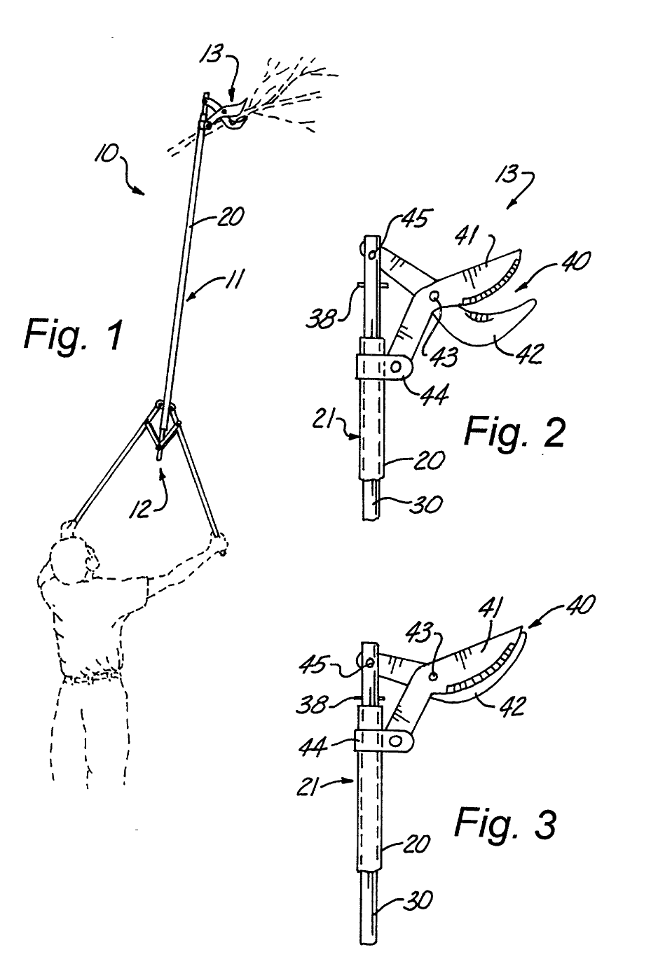

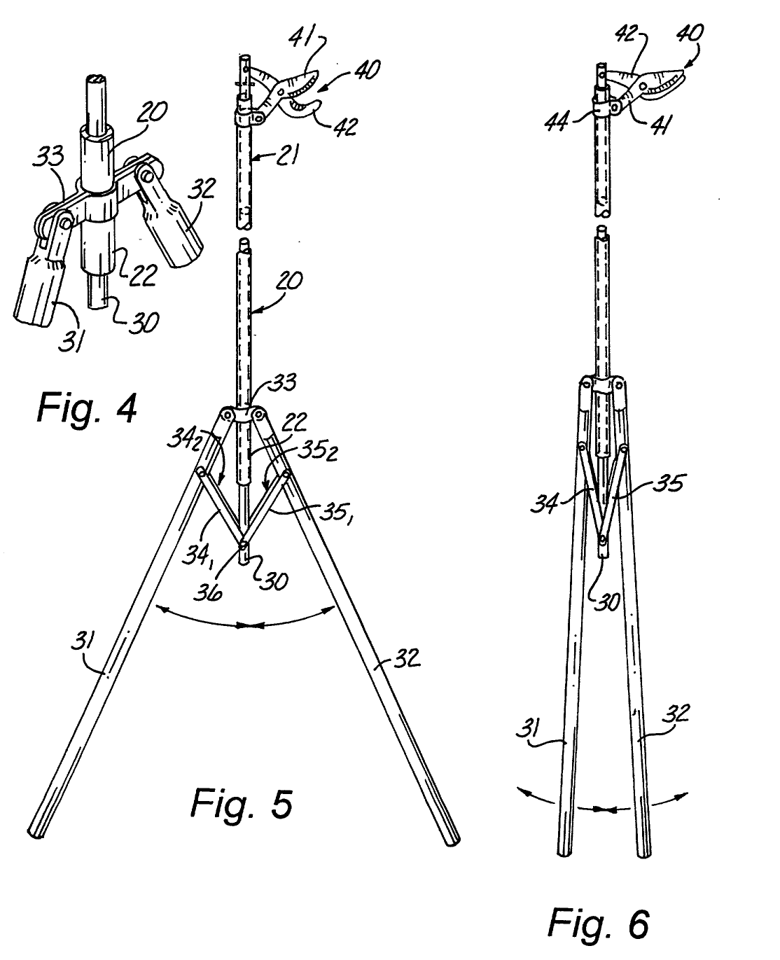

As can be seen by reference to the drawings, and in particular to FIG. 1, the pruning device for high tree branches that forms the basis of the present invention is designated generally by the reference number 10. The pruning device 10 comprises in general a shaft unit 11, an actuator unit 12 and a clipping unit 13. These units will now be described in seriatim fashion.

As shown in FIGS. 1, 5, and 6, the shaft unit 11 comprises an elongated hollow cylindrical shaft member 20 having an upper portion 21 and a lower portion 22.

As can also be appreciated by reference to FIGS. 1, 5, and 6, the actuator unit 12 comprises an elongated actuator rod 30 dimensioned to be slidably received within and extend beyond the upper and lower ends of the hollow shaft member 20 for reasons that will be explained presently.

The actuator unit 12 also includes a pair of elongated actuator arm members 31 32 whose upper ends are pivotally connected to the opposite sides of a yoke member 33 that is fixedly secured on the lower portion 22 of the hollow shaft member 20; and a pair of linkage arms 34 35 that are pivotally secured on their lower ends as at 36 to the lower portion of the actuator rod member 30 and whose upper ends are pivotally secured respectively on the upper portion of each of the pair of actuator arm members 31 32.

Turning now to FIGS. 2, 3, 5, and 6, it can be appreciated that when the actuator arm members are pivoted toward one another, the actuator rod member 30 will be forced downwardly within the hollow shaft member 20 and when the actuator arm members 31 32 are spread apart from one another, the actuator rod member 30 will be forced upwardly relative to the hollow shaft member 20 for reasons that will be explained presently.

In addition, the clipper unit 13 comprises a clipper member 40 having a pair of clipper jaw elements 41 42 pivotally connected to one another as at 43 wherein one of the clipper jaw elements 41 has an inboard end fixedly connected to the upper portion 21 of the hollow shaft member 20 via a collar element 44 and the other jaw element 42 has an inboard end pivotally connected as at 45 to the upper end of the actuator rod member 30.

Furthermore, as can best be seen by reference to FIGS. 2 and 3, the upper end of the actuator rod member 30 is further provided with a stop pin 38 that limits the downward movement of the upper end of the hollow shaft member 20 in a well recognized fashion.

In operation, the user of the pruning device 10 would maneuver the upper portion thereof adjacent to a branch or succor stem to be pruned with the actuator arm members 31 32 spread wide apart to facilitate the positioning of the clipper unit 13. Then once the jaw elements 41 42 of the clipper member 40 are disposed on either side of the chosen branch or stem, the actuator arm members 31 32 are pivoted toward one another to close the jaw elements 41 42 to effect the desired pruning cut.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A pruning device for cutting the higher branches of a tree wherein the pruning device comprises:
a shaft unit including an elongated hollow shaft member having an upper portion and a lower portion
an actuator unit including an elongated actuator rod dimensioned to be slidably received in the elongated shaft member and having an upper end and a lower end wherein the length of the actuator rod is greater than the length of the hollow shaft member.

2. The device as in claim 1; further comprising second means for limiting the travel of the actuator rod in at least one direction relative to the hollow shaft member.

3. The device as in claim 1; wherein, said first means comprises at least in part
at least one actuator arm member pivotally associated with both the lower portion of the hollow shaft member and the lower end of the actuator rod.

4. The device as in claim 2; wherein, said second means comprises a stop pin disposed on the upper end of the actuator rod and adapted to engage the upper portion of the hollow shaft member.

5. The device as in claim 3; wherein, the upper end of the actuator rod is further provided with a stop pin adapted to engage the upper portion of the hollow shaft member.

6. The device as in claim 1; wherein, said first means comprises
a pair of actuator arm members pivotally connected to the lower portion of the hollow shaft member and operatively connected to the lower end of the actuator rod by a pair of linkage arms.

7. The device as in claim 6; wherein, each of the pair of linkage arms has one end pivotally connected to one of the pair of actuator arm members and the other end pivotally connected to the lower end of the actuator rod.

8. The device as in claim 2; wherein, said first means comprises
a pair of actuator arm members pivotally connected to the lower portion of the hollow shaft member and operatively connected to the lower end of the actuator rod by a pair of linkage arms.

9. The device as in claim 8; wherein, each of the pair of linkage arms has one end pivotally connected to one of the pair of actuator arm members and the other end pivotally connected to the lower end of the actuator rod.
